(19) United States
(12) Patent Application Publication
(10) Pub. No.: US 2026/0273709 A1
(43) Pub. Date: Sep. 17, 2026

(54) Bumper Element for a Tool, a Venting Structure, and a Tool

(71) Applicants: Bosch Power Tools (China) Co., Ltd., Hangzhou (CN); Robert Bosch GmbH, Stuttgart (DE)

(72) Inventors: Jian Wang, Hangzhou (CN); Simon Dorsch, Leinfelden-Echterdingen (DE)

(21) Appl. No.: 19/563,476

(22) Filed: Mar. 11, 2026

(30) Foreign Application Priority Data
Mar. 17, 2025 (CN) 2025 1031 0932.4

(51) Int. Cl. B25C 1/04

(52) U.S. Cl. CPC B25C 1/041

(57) ABSTRACT

A bumper element for a tool is disclosed. The bumper element has a bearing end face located at one end in the axial direction and a supporting end face located at the other end in the axial direction. At least one groove is provided on a circumferential surface between the supporting end face and the bearing end face to increase the surface area of the circumferential surface.

This application claims priority under 35 U.S.C. § 119 to application no. CN 2025 1031 0932.4, filed on Mar. 17, 2025 in China, the disclosure of which is incorporated herein by reference in its entirety.

The present disclosure relates to a bumper apparatus, in particular to a bumper apparatus for a handheld tool.

### BACKGROUND

Tools that generate impact are frequently used in many industries, such as construction and manufacturing. For example, a gas spring nail gun, or nailer, mainly relies on compressed gas to drive a spring to drive a cylinder piston, which in turn pushes the nail into the substrate at high speed. However, during this process, the piston will still carry a portion of the initial kinetic energy and continue to move upon completion of the nailing action. Failure to deal with this part of the energy in a timely manner poses a series of serious problems. On the one hand, the piston will have a rigid collision with the gun body, which will not only seriously affect the service life of the nail gun, but may also lead to safety incidents; on the other hand, excessive recoil will directly act on the operator, resulting in hand strain for the operator and possibly even operational errors.

As a result, current nail guns often employ a bumper to brake the piston and absorb the remaining energy. In general, the larger the size of the bumper, the better the energy absorption effect, and the longer the service life of the bumper, the longer the service life of the tool.

However, on the other hand, as tools are becoming more lightweight and portable, the size of the bumper needs to be as small as possible, which limits the improvement in the service life of the bumper.

### SUMMARY

One of the objectives of the present disclosure is to provide a bumper element for a tool that can reduce product size, enhance heat dissipation performance, and increase service life while ensuring energy absorption.

To achieve the above objective, the present disclosure proposes a bumper element for a tool having a bearing end face located at one end in the axial direction and a supporting end face located at the other end in the axial direction, wherein at least one groove is provided on a circumferential surface between the supporting end face and the bearing end face to increase the surface area of the circumferential surface.

Another objective of the present disclosure is to provide a venting structure for a tool that, while having excellent energy absorption, also enables efficient venting of the tool, thereby providing better ease of use.

Based on the above disclosure objectives, the present disclosure further provides a venting structure for a tool, comprising a base, a cylinder being disposed on the base and sealed to the base and a piston being provided inside the cylinder and moving along the axial direction of the cylinder; wherein the venting structure further comprises a bumper element as described above, the bumper element being supported on the base by its supporting end face, a first vent hole being provided on the side wall of the cylinder at a position corresponding to the end of at least one groove, and the gas inside the cylinder being vented at least through the groove and the first vent hole.

Yet another objective of the present disclosure is to provide a tool that has excellent energy absorption, high venting efficiency, and good user experience.

Based on the above objective, the present disclosure further provides a tool comprising a housing and a base sealed to the housing, a cylinder sealed to the base being provided within the housing, a piston being provided within the cylinder and moving along the axial direction of the cylinder, and the movement of the piston along the axial direction of the cylinder actuating the tool; wherein a bumper element as described above is supported on the base by its supporting end face, its bearing end face facing the piston, a first vent hole being provided on the side wall of the cylinder at a position corresponding to the end of at least one groove, a second vent hole being provided on the housing, and the gas within the cylinder being vented from the tool at least through the groove, the first vent hole, and the second vent hole.

In some embodiments, the tool of the present disclosure comprises a gas spring nail gun.

The bumper element for a tool of the present disclosure that can reduce product size, enhance heat dissipation performance, and increase service life while ensuring energy absorption. It also ensures stable performance in a variety of working conditions, providing a good balance between energy absorption and recoil control, thereby improving the overall performance and safety of the tool and reducing the cost of use.

### BRIEF DESCRIPTION OF THE DRAWINGS

FIG. 1 shows the three-dimensional structure of the bumper element of the present disclosure in one embodiment from one perspective.

FIG. 2 shows the three-dimensional structure of the bumper element of the present disclosure in one embodiment from another perspective.

FIG. 3 shows the structure of the bumper element of the present disclosure in one embodiment from a frontal perspective.

FIG. 4 shows the groove of the bumper element of the present disclosure in one embodiment.

FIG. 5 schematically shows the structure of the venting structure of the present disclosure in one embodiment.

### DETAILED DESCRIPTION

Further explanation and description of the bumper element for a tool, venting structure, and tool described herein will be provided below in conjunction with the accompanying drawings and specific embodiments of the specification. However, the explanation and description do not constitute an undue limitation on the technical solution of the present disclosure.

Nail guns mainly rely on compressed gas to drive a spring, which in turn drives a cylinder piston to move rapidly, thereby propelling the nail into the substrate at high speed. However, during this process, the piston will still carry a portion of the initial kinetic energy and continue to move upon completion of the nailing action. Failure to deal with this part of the energy in a timely manner poses a series of serious problems. On the one hand, the piston will have a rigid collision with the gun body, which will not only seriously affect the service life of the nail gun, but may also lead to safety incidents; on the other hand, excessive recoil will directly act on the operator, resulting in hand strain for the operator and possibly even operational errors.

As a result, current nail guns often employ a bumper to brake the piston and absorb the remaining energy. In general, the larger the size of the bumper, the better the energy absorption effect, and the longer the service life of the bumper, the longer the service life of the tool.

However, on the other hand, as tools are becoming more lightweight and portable, the size of the bumper needs to be as small as possible, which limits the improvement in the service life of the bumper.

In order to address the above problems, the present disclosure provides a bumper element for a tool in one embodiment.

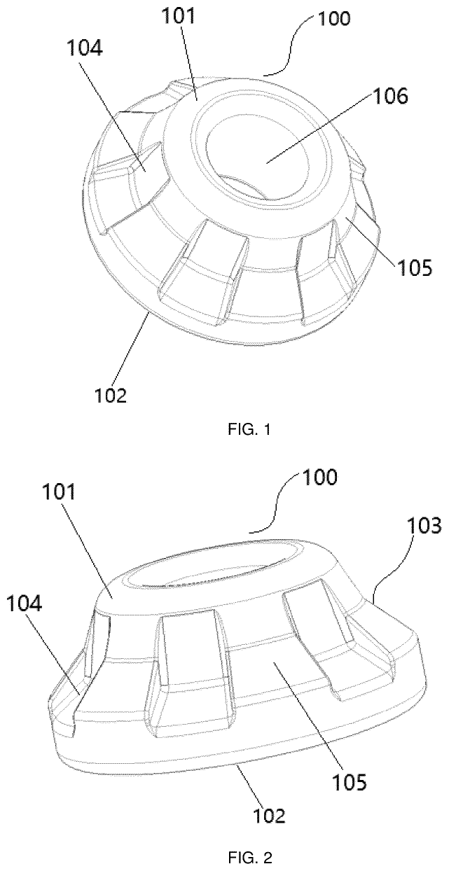

FIG. 1 shows the three-dimensional structure of the bumper element of the present disclosure in one embodiment from one perspective.

FIG. 2 shows the three-dimensional structure of the bumper element of the present disclosure in one embodiment from another perspective.

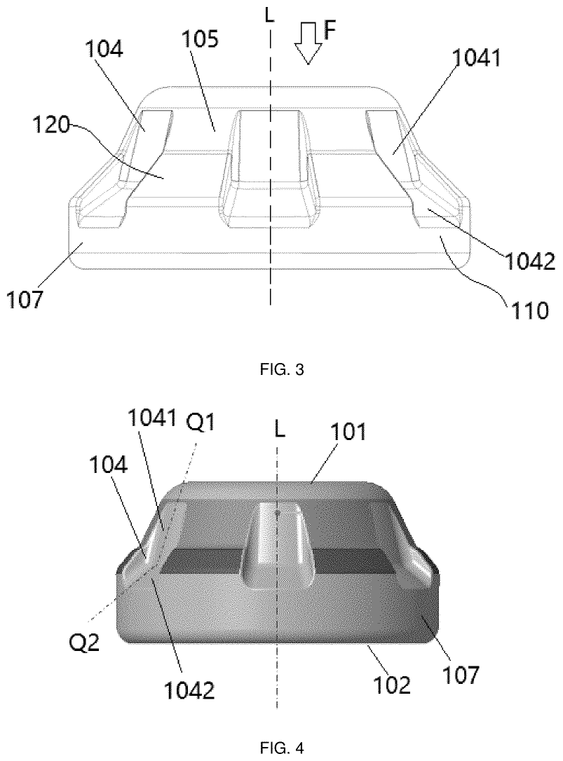

FIG. 3 shows the structure of the bumper element of the present disclosure in one embodiment from a frontal perspective.

As shown in FIGS. 1, 2, and 3, in some embodiments, a bumper element 100 for a tool has a bearing end face 101 located at one end in the axial direction and a supporting end face 102 located at the other end in the axial direction, wherein the bumper element 100 is supported within the tool by its supporting end face 102 and the bearing end face 101 is used to contact a piston moving within the tool, thereby bearing the impact force F of the piston substantially along the axial direction L of the bumper element 100 when the bumper element 100 is disposed within the tool.

As shown in FIGS. 1, 2, and 3, at least one groove 104 is provided on the circumferential surface 103 between the supporting end face 102 and the bearing end face 101, thereby forming a rib 105 protruding relative to the groove between the groove 104. By forming a recessed groove and a protruding rib on the circumferential surface, the surface area of the circumferential surface is greatly increased compared to a circumferential surface without grooves and ribs, increasing the heat dissipation area of the bumper element and thus improving the service life of the bumper element within a limited volume.

It is to be noted that in the present disclosure, the bumper element is made of a material that can absorb impact kinetic energy and then undergo elastic deformation, such as rubber.

In some embodiments, in order to further reduce the weight of the bumper element while ensuring the structural strength of the bumper element, an axial through hole 106 may be provided in the middle of the bumper element 100, as shown in FIG. 1.

As shown in FIGS. 1, 2, and 3, in some more specific embodiments, the groove 104 of the bumper element 100 extends between the bearing end face 101 and the supporting end face 102. It is to be noted that this does not mean that the extension length of the groove extends from the bearing end face to the supporting end face, but rather that in this embodiment, the extension direction of the groove 104 is from the bearing end face 101 to the supporting end face 102, or from the supporting end face 102 to the bearing end face 101.

Of course, given that the purpose of the present disclosure in providing the groove is to increase the area of the circumferential surface, in some other more specific embodiments, the extension direction of the groove may also be in the circumferential direction of the bumper element, or obliquely on the circumferential surface (i.e., at an angle to the vertical direction). It could also be other irregular methods of extension.

However, considering the ease of processing and manufacturing as well as the direction of airflow within the tool, the extension direction of the groove 104 is preferably from the bearing end face 101 to the supporting end face 102, or from the supporting end face 102 to the bearing end face 101. Furthermore, the groove 104 extending from the bearing end face 101 to the supporting end face 102, or from the supporting end face 102 to the bearing end face 101, also forms a rib 105 extending in the same direction. This rib points in the direction of the impact force, thereby improving the impact resistance of the bumper element.

Additionally, in some more specific embodiments, the extension direction of the groove 104 is at least partially non-parallel to the axial direction L of the bumper element.

It is to be noted that the groove 104 extends between the bearing end face 101 and the supporting end face 102, but this does not imply that the extension direction of the groove is necessarily parallel to the axial direction of the bumper element. Conversely, in order to further increase the area of the circumferential surface on a limited circumferential surface, in some more specific embodiments, it is desirable that the extension direction of the groove 104 is at least partially non-parallel to the axial direction L of the bumper element, that is, at least a portion of the bottom surface of the groove is not parallel to the axial tangent of the bumper element, but rather at an angle to it. This configuration not only helps to further increase the circumferential surface area, but also enables the side venting of the tool when the bumper element is installed in conjunction with the tool's cylinder (as will be described below), thereby improving venting efficiency.

Moreover, since the extension direction of the groove 104 is at least partially non-parallel to the axial direction L of the bumper element, both the groove 104 and the rib 105 on the side of the groove have a portion of their surface inclined relative to the axial direction. The pressure of the compressed gas applied to this inclined surface can also prevent the bumper element from bouncing axially upward after being impacted by the piston, thereby improving the stability of the bumper element during use.

In some more specific embodiments, as shown in FIG. 4, the groove 104 comprises a first portion 1041 having a first angle with the axial direction L and a second portion 1042 having a second angle with the axial direction L. As shown in FIG. 4, in this embodiment, the extension direction of the groove 104 is not always consistent, so it has at least two portions whose extension directions are not parallel to the axial direction L. The angle between the extension direction Q1 of the first portion 1041 and the axial direction L is different from the angle between the extension direction Q2 of the second portion 1042 and the axial direction L.

In some more specific embodiments, as shown in FIG. 4, the second portion 1042 of the groove is closer to the supporting end face 102 than the first portion 1041, and the second angle between the extension direction Q2 of the second portion 1042 and the axial direction L is greater than the first angle between the extension direction Q1 of the first portion 1041 and the axial direction L. This means that while further increasing the circumferential surface area, the outer circumferential diameter of the supporting end face 102 of the bumper element is larger than the outer circumferential diameter of the bearing end face 101. This can further enhance the support capacity of the bumper element.

Of course, in some other more specific embodiments, the extension direction of the first portion may also be parallel to the axial direction, and the extension direction of the second portion may have a certain angle with the axial direction. This can similarly improve the support capacity of the bumper element, but it is not as effective at increasing the circumferential surface area as the above embodiments.

As shown in FIGS. 3 and 4, in some more specific embodiments, the end of the groove 104 along the extension direction has a distance from the supporting end face 102, that is, the end of the groove does not extend directly to the supporting end face. By using this arrangement in this embodiment, a base 107 without grooves is formed at the position of the bumper element near the supporting end face 102, thereby further ensuring the support strength of the bumper element and improving its impact resistance.

In some more specific embodiments, as shown in FIGS. 3 and 4, the bumper element comprises a cylindrical segment 110 disposed at one end of the supporting end face along the axial direction and a frustum segment 120 disposed at one end of the supporting end face, and the grooves 104 are all disposed on the frustum segment 120. That is, each radial cross-section of the bumper element is circular.

In this embodiment, the cylindrical segment 110 forms the base 107 described above. To ensure the support strength at a point, the cylindrical segment 110 can extend in the axial direction by at least 1 mm, e.g., 1-3 mm.

In some more specific embodiments, in order to maximize the surface area on a limited circumferential surface, it is preferable to provide a plurality of grooves, and for ease of processing, these grooves can be evenly distributed along the circumferential direction of the bumper element.

In some more specific embodiments, taking into account factors such as increasing the circumferential surface area, processing cost, and convenience, 6-15 grooves 104 can be provided along the circumferential direction of the bumper element.

With this configuration, the present disclosure achieves a compact design, namely a smaller cylinder diameter, a lower bumper height, a smaller diameter, and a lighter tool weight, while also extending the service life of the bumper element. The inventors have verified through service life test experiments that it can withstand more than 100,000 piston impacts. Moreover, the bumper element is simple in structure and inexpensive in terms of manufacturing costs.

Since the tool needs to vent gas during use, in conjunction with the bumper element described above, the present disclosure further provides a venting structure for the tool in one embodiment.

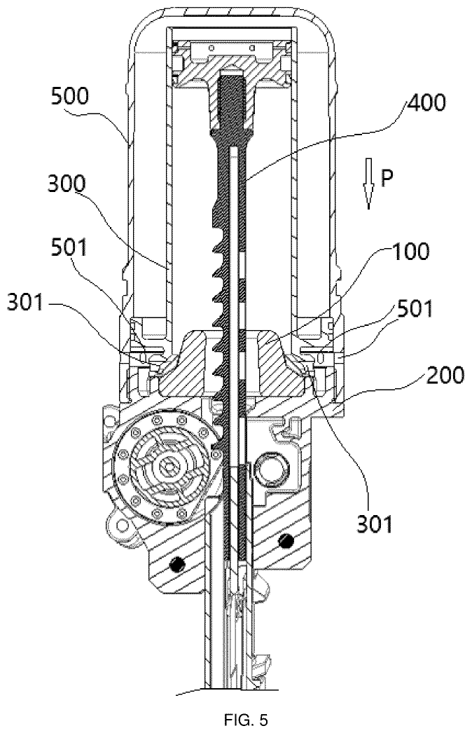

FIG. 5 schematically shows the structure of the venting structure of the present disclosure in one embodiment.

As shown in FIG. 5, in some embodiments, the venting structure is part of a tool, which comprises a base 200, a cylinder 300 disposed on the base 200 and sealed to the base, and a piston 400 provided within the cylinder and moving along the axial direction of the cylinder. A bumper element 100 is supported on the base 200 by its supporting end face 102.

During the firing of the nail, the piston moves along direction P. At the same time, the tool needs to vent gas during use. Generally, the gas in the cylinder is vented through the gap between the piston 400 and the base 200.

However, in some embodiments of the present disclosure, a first vent hole 301 is provided on the side wall of the cylinder 300 at the position corresponding to the end of at least one groove of the bumper element 100. In this way, the groove on the circumferential surface of the bumper element also serves as a venting channel. The gas in the cylinder can be vented through the groove 104 and the first vent hole 301, thereby adding a path for venting from the side of the cylinder in addition to the original path of venting gas through the gap between the piston 400 and the base 200, which greatly improves venting efficiency.

The present disclosure further provides, in one embodiment, a tool, such as a gas spring nail gun.

As shown in FIG. 5, a portion thereof shows the structure of a gas spring nail gun. The gas spring nail gun comprises a housing 500 and a base 200 sealed to the housing. A cylinder 300 sealed to the base is provided within the housing 500, and a piston 400 is provided within the cylinder 300 and moves along the axial direction of the cylinder The bumper element 100 is supported on the base 200 by its supporting end face 102, and its bearing end face 101 faces the piston 400.

When the piston 400 moves downward along the cylinder axial direction P, the nail in the accommodating cavity of the base is knocked out. At the same time, the piston 400 hits the bumper element 100, and the bumper element 100 undergoes elastic deformation to absorb the impact kinetic energy of the piston 400.

In conjunction with FIGS. 4 and 5, it can be seen that in some more specific embodiments, since the extension direction of the groove 104 is at least partially non-parallel to the axial direction L of the bumper element, both the groove 104 and the rib 105 on the side of the groove have a portion of their surface inclined relative to the axial direction. The pressure of the compressed gas applied to this inclined surface can also effectively prevent the bumper element from bouncing axially upward after being impacted by the piston (that is, bouncing in the direction opposite to direction P), thereby improving the stability of the bumper element during use.

Further, as shown in FIG. 5, a first vent hole 301 is provided on the side wall of the cylinder 300 at the position corresponding to the end of at least one groove 104 of the bumper element 100, and a second vent hole 501 is provided on the housing 500 that communicates with the space between the housing and the cylinder. In some more specific embodiments, a plurality of second vent holes 501 are provided along the circumferential direction of the housing 500. Accordingly, in addition to the original path of gas venting through the gap between the piston 400 and the base 200, the gas can also be vented into the space between the cylinder and the housing through the groove of the bumper element 100, which serves as a venting channel, and the first vent hole 301 and further vented out of the tool through the second vent holes 501.

It is to be noted that the tools of the present disclosure comprise, inter alia, gas spring nail guns.

It is to be noted that the prior art portion of the protective scope of the present disclosure is not limited to the embodiments given in the present specification. All prior art that does not contradict the solution of the present disclosure, including but not limited to prior patent documents, prior publications, prior public uses, etc., can be included in the protective scope of the present disclosure.

In addition, the combinations of the various technical features in the present disclosure are not limited to the combinations recorded in the claims of the present disclosure or the combinations recorded in the specific embodiments. All the technical features recorded in the present disclosure may be freely combined or combined in any manner, unless there is a conflict between them.

It is also to be noted that the embodiments listed above are only specific embodiments of the present disclosure. Obviously, the present disclosure is not limited to the above embodiments. Any similar changes or modifications made thereto that can be directly derived or easily conceived by those skilled in the art from the content disclosed in the present disclosure should fall within the protective scope of the present disclosure.

What is claimed is:

1. A bumper element for a tool, comprising:
a bearing end face located at one end of the bumper element in an axial direction;
a supporting end face located at the other end of the bumper element in the axial direction, and
a circumferential surface interposed between the supporting end face and the bearing end face,
wherein at least one groove is provided on the circumferential surface and configured to increase a surface area of the circumferential surface.

2. The bumper element according to claim 1, wherein the at least one groove extends between the bearing end face and the supporting end face.

3. The bumper element according to claim 1, wherein an extension direction of the at least one groove is at least partially non-parallel to the axial direction of the bumper element.

4. The bumper element according to claim 3, wherein the at least one groove includes a first portion defining a first angle with the axial direction and a second portion defining a second angle with the axial direction.

5. The bumper element according to claim 4, wherein:
the second portion is closer to the supporting end face than the first portion, and
the second angle is greater than the first angle.

6. The bumper element according to claim 3, wherein an end of the at least one groove along the extending direction is located a distance from the supporting end face.

7. The bumper element as claimed in claim 1, wherein:
the at least one groove includes a plurality of grooves, and
the plurality of the grooves are evenly distributed along a circumferential direction of the bumper element.

8. The bumper element as claimed in claim 1, wherein the at least one groove includes at least six grooves but no more than fifteen grooves disposed along a circumferential direction of the bumper element.

9. The bumper element according to claim 1, wherein the circumferential surface includes:
a cylindrical segment disposed at one end of the supporting end face along the axial direction, and
a frustum segment positioned adjacent to the cylindrical segment, and
the at least one groove is disposed on the frustum segment.

10. The bumper element according to claim 9, wherein the cylindrical segment extends at least 1 mm in the axial direction.

11. A venting structure for a tool, comprising:
a base;
a cylinder disposed on the base and sealed to the base;
a piston provided inside the cylinder and configured to move along the axial direction of the cylinder; and
the bumper element of claim 1,
wherein the bumper element is supported on the base by the supporting end face,
wherein a first vent hole is provided on the side wall of the cylinder at a position corresponding to the end of the at least one groove, and
wherein gas inside the cylinder is vented at least through the at least one groove and the first vent hole.

12. A tool, comprising:
a housing;
a base sealed to the housing;
a cylinder sealed to the base and located within the housing;
a piston located within the cylinder and configured to move along the axial direction of the cylinder, wherein movement of the piston along the axial direction of the cylinder actuates the tool; and
the bumper element of claim 1,
wherein the bumper element is supported on the base by the supporting end face,
wherein the bearing end face faces the piston,
wherein a first vent hole is provided on a side wall of the cylinder at a position corresponding to the end of at least one groove,
wherein a second vent hole is provided on the housing, and
wherein gas within the cylinder is vented from the tool at least through the groove, the first vent hole, and the second vent hole.

13. The tool according to claim 12, wherein the tool is a gas spring nail gun.
